(19) United States
(12) Patent Application Publication
(10) Pub. No.: US 2009/0293120 A1
(43) Pub. Date: Nov. 26, 2009

(54) ANTI-THEFT METHOD AND APPARATUS WITH WIRELESS TECHNOLOGIES

(75) Inventors: Lei Feng, Shanghai (CN); Xialou Sun, Shanghai (CN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/722,082

(22) PCT Filed: Dec. 7, 2005
(86) PCT No.: PCT/IB2005/054095

§ 371 Date: Jun. 18, 2007

(30) Foreign Application Priority Data
Dec. 17, 2004 (CN) 200410102011.7

(51) Int. Cl. G06F 12/14; G08B 21/00

(52) U.S. Cl. 726/21; 340/540

(57) ABSTRACT

An anti-theft method to be executed in an active peer, comprising: (a) transmitting radio RF signals to a passive peer to detect whether one of the active peer and the passive peer as a monitored object is in the coverage area of the radio range of the other one of the active peer and the passive peer as a dock; (b) checking whether the monitored object is permitted to leave the dock when detecting that the monitored object is going to leave the area of the dock; (c) sending an alarm signal to an alarm apparatus if the monitored object is not permitted to leave the dock.

### FIELD OF THE INVENTION

The present invention relates generally to an anti-theft method and apparatus, and more particularly, to an anti-theft method and apparatus by using short range wireless communication technologies.

### BACKGROUND ART OF THE INVENTION

In our daily life, generally people can take good care of their private articles. But for public shared articles, especially those likely to be shared by several people during some period, due to the uncertainty as to when each user will borrow them and where they are used, the administrators often fall to a passive situation because they have no way to determine which user is using a certain article in a certain period. Slight carelessness is likely to cause the public shared articles missing.

In a company, among the purchased devices like mobile phone, PDA, laptop computer, wireless thin client and so on, only a few are dedicated for some special persons, such as department managers and salesmen, and most devices are usually shared by many employees according to the requirements of their respective tasks.

It has long been a problem to be settled as how to enable employees to use these public shared devices for their working purposes conveniently and manage these public shared devices effectively meanwhile.

### OBJECT AND SUMMARY OF THE INVENTION

An object of the present invention is to provide an anti-theft method and apparatus, with which alarm signals are generated timely when a monitored public device is brought out of the predefined surveillance area without authorization.

An anti-theft method to be executed in an active peer according to the present invention, comprising: transmitting radio RF signals to a passive peer, to detect whether one of the active peer and the passive peer as a monitored object is in the coverage area of the radio range of the other one of the active peer and the passive peer as a dock; checking whether the monitored object is permitted to leave the dock when detecting that the monitored object is going to leave the area of the dock; sending an alarm signal to an alarm apparatus if the monitored object is not permitted to leave the dock.

An anti-theft method to be executed in a surveillance server according to the present invention, comprising: receiving the alarm signal sent from an active peer, the alarm signal signifying that a monitored object leaves the coverage area of the radio range of a dock without authorization, wherein one of the monitored object and the dock having power supply component acts as the active peer while the other one acts as a passive peer to receive radio RF signals sent from the active peer; generating an alarm indication based on the alarm signal.

An active apparatus according to the present invention, comprising: a transmitting unit, for transmitting radio RF signals to a passive peer, to detect whether one of the active peer and the passive peer as a monitored object is in the coverage area of the radio range of the other one of the active peer and the passive peer as a dock; a detecting unit, for checking whether the monitored object is permitted to leave the dock when detecting that the monitored object is going to leave the area of the dock; wherein the transmitting unit sends an alarm signal to the surveillance server if the checking result shows that the monitored object is not permitted to leave the dock.

A surveillance server according to the present invention, comprising: a receiving unit, for receiving the alarm signal sent from an active peer, the alarm signal signifying that a monitored object leaves the coverage area of the radio range of a dock without authorization, wherein one of the monitored object and the dock having power supply component acts as the active peer while the other one acts as a passive peer to receive radio RF signals sent from the active peer; an alarming unit, for generating an alarm indication based on the alarm signal.

Other objects and attainments together with a fuller understanding of the invention will become apparent and appreciated by referring to the following description and claims taken in conjunction with the accompanying drawings.

### BRIEF DESCRIPTION OF THE DRAWINGS

Detailed descriptions will be given below to the present invention in conjunction with specific embodiments and accompanying drawings, in which:

FIG. 1 is the schematic diagram illustrating the anti-theft system sending alarm signals to the surveillance server via a mobile device in accordance with an embodiment of the present invention;

FIG. 2A and FIG. 2B are flowcharts illustrating the steps to be executed in the mobile device and those in the surveillance server respectively when the anti-theft system shown in FIG. 1 is adopted;

FIG. 3 is the schematic diagram illustrating the anti-theft system sending alarm signals to the surveillance server via the docks in accordance with another embodiment of the present invention;

FIG. 4A and FIG. 4B are flowcharts illustrating the steps to be executed in the dock and those in the surveillance server respectively when the anti-theft system shown in FIG. 3 is adopted;

FIG. 5 is the block diagram illustrating the active peer for sending alarm signals to the surveillance server and the surveillance server for generating alarms in accordance with an embodiment of the present invention.

Throughout the drawing figures, like reference numerals will be understood to refer to like parts and components.

### DETAILED DESCRIPTION OF THE INVENTION

A mobile device, such as mobile phone, PDA and portable computer, generally has several communication interfaces. One or more wireless communication interfaces are often included in these interfaces, to support wireless communication based on WLAN, Bluetooth, Near Field Communication or RFID technologies.

Since these wireless communication technologies have their own respective radio coverage, a mobile device equipped with the wireless communication interfaces shoulders the responsibility of restricting itself in the surveillance area within the reach of the radio range and sending alarm signals to the surveillance server when the mobile device is brought out of the surveillance area without permission, in addition to normal communication functionality within a certain area. Based on the characteristics of these short range (or limited radio coverage) wireless communication technologies, the present invention aims to establish a secure anti-theft system for public shared articles similar to the mobile device.

Descriptions are given below to the anti-theft system for preventing public articles from being stolen in the present invention, in conjunction with accompanying drawings, exemplified by a wireless communication interface based on Philips Mifare (a RFID technology).

According to Mifare, a passive peer gets the working power through being activated by a active peer, and then establishes radio link with the active peer. Regarding the anti-theft system in the present invention, of the monitored mobile device and the dock carrying out surveillance, the one having power supply component acts as the active peer, while the other one acts as the passive peer. When the mobile device leaves the surveillance area of the dock without permission, that is, the radio link between the mobile device and the dock breaks after the mobile device moves out of the radio range of Mifare, one party acting as the active peer sends alarm signals to the surveillance server to warn that the mobile device is being stolen possibly.

The anti-theft system in the present invention provides two surveillance modes, taking the mobile device and the dock as the active peer respectively. Two specific embodiments will be given below to describe the two surveillance modes.

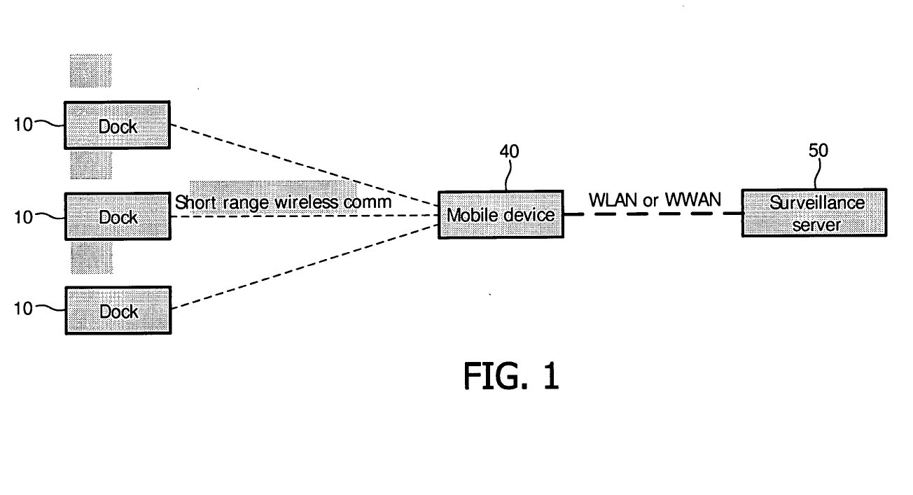

FIG. 1 is the schematic diagram illustrating the anti-theft system where alarm signals are sent to the surveillance server via the mobile device (i.e. the mobile device acts as the active peer) in accordance with an embodiment of the present invention. As shown in FIG. 1, a plurality of docks 10 can be deployed in a predefined surveillance area (e.g. office building or plant area), each dock 10 acting as an active peer.

According to the radio range of Mifare (usually 10 cm), mobile device 40 having power supply component and acting as the active peer, reports the identification information of the dock to which it belongs to surveillance server 50 when detecting a dock 10 in its radio range. Here, the coverage area of the radio signals transferred between dock 10 and mobile device 40 with dock 10 at the center, is called governing area of dock 10. When mobile device 40 detects that it leaves the dock to which it belongs and enters the governing area of another dock 10, it reports the identification information of the new dock to which it belongs to surveillance server 50. When the mobile device 40 detects that it leaves the predefined surveillance area without permission, it sends alarm signals to surveillance server 50.

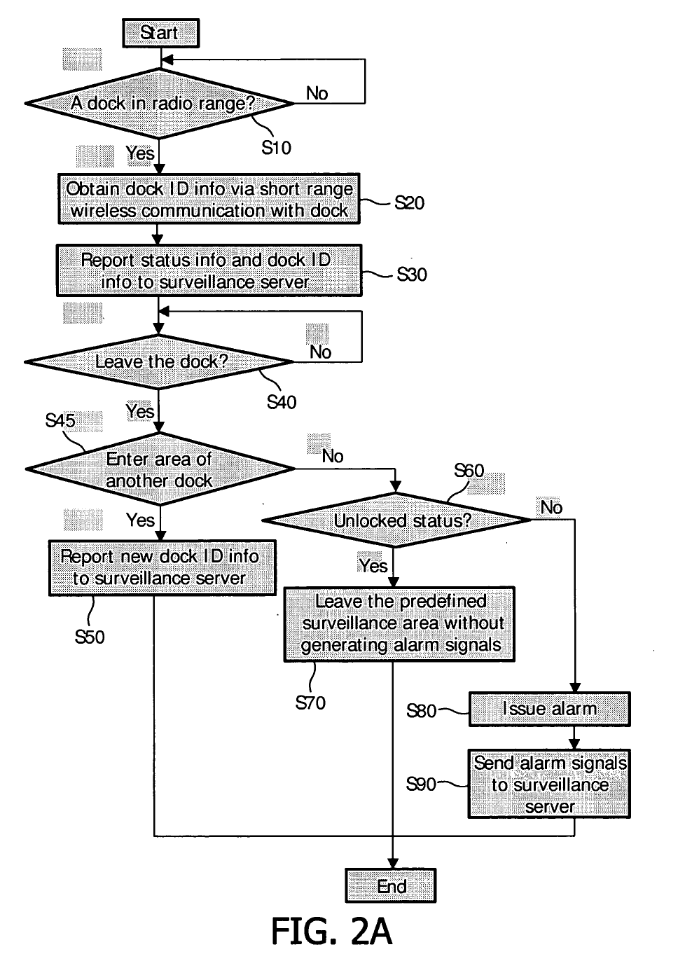

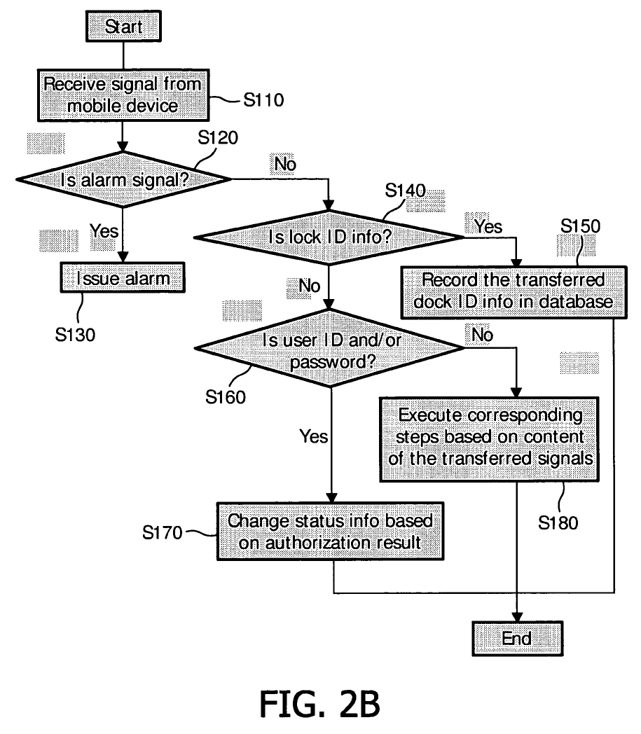

The following section will describe the steps respectively to be executed in mobile device 40 and surveillance server 50 of FIG. 1, in conjunction with FIG. 2A and FIG. 2B.

As shown in FIG. 2A, first, the mobile device attempts to establish radio link with each dock and thus detects whether there exists a dock in its radio range (step S10).

According to the operational principle of Mifare, the mobile device keeps on sending radio signals to detect whether there exists a dock in its radio range. If there exists a dock in the radio range of the radio signal, the dock activated by the radio signal establishes radio link with the mobile device. Once the mobile device detects a dock, it transfers into locked state automatically (i.e. not allowed to leave the governing area of the dock without permission). At this time, the radio link between the mobile device and the dock is just like an electronic lock, locking mobile device 40 in the governing area of the dock.

Assuming that each dock within the anti-theft system has its respective identity, the mobile device obtains the identification information of the dock to which it belongs via the short range wireless communication with the dock (step S20), wherein the identity of the dock can be a string of symbols, like 200070, or a character string indicating location information, like workshop A.

After acquiring the identification information of the dock to which it belongs, the mobile device reports the status information indicating it is in locked status together with the identification information of the dock to which it belongs, to the surveillance server via WLAN or WWAN (step S30).

When the mobile device moves in the governing area of the dock, e.g. a pick-up sensor installed in the mobile device detects that the mobile is being moved, a monitoring module in the mobile device is enabled to detect whether it has left the dock to which it belongs, that is, detect whether the radio link between the mobile device and the dock to which it belongs breaks (step S40).

Alternatively, the mobile device can also detects at predefined intervals (2 second, for example) whether it has left the dock to which it belongs and reports the detection results to the surveillance server regularly, which can enable the surveillance server failing to receive any detection result in a predefined time period to issue an alarm, and thus prevent the thief from cutting the power supply component and thus stealing the mobile device, compared with the detection mode adopting shift sensor.

The mobile device moving in the governing area of a dock, could leave the governing area of the dock and enter the governing area of another dock, or could leave the predefined whole surveillance area formed by a plurality of docks, so we should first determine whether the mobile device moves into the governing area of a new dock (step S45).

If the mobile device detects that it has entered the governing area of a new dock, after obtaining the identification information of the new dock via short range wireless communication, it reports the identification information of the new dock to the surveillance server (step S50).

If the mobile device detects that it is leaving the governing area of the dock to which it currently belongs and has not entered the governing area of another new dock yet but attempts to leave the predefined governing area, the mobile device checks whether the current status has changed from locked status to unlocked status (step S60).

In the embodiment of the present invention, the mobile device can receive user ID (i.e. user name) and/or password from user input via smart card or keyboard. After performing authentication procedure with the surveillance server and receiving the confirmation message indicating that the inputted user ID and/or password are/is from an authorized user, the mobile device changes from locked status to unlocked status (that is, it has been granted the authorization to leave the governing area of the dock).

If the mobile device is in unlocked status currently, it can leave the predefined surveillance area without generating alarm signals (step S70); however, if the mobile device is still in locked status, it will issue an alarm through its own alarm apparatus (step S80), and send an alarm signal to the surveillance server to warn the surveillance server that the mobile device is possibly being stolen (step S90).

To enhance security of the anti-theft system, the mobile device will resumes to locked status from unlocked status automatically if the mobile device in unlocked status hasn't left the governing area of the dock to which it belongs within a predefined time period, thus to prevent the mobile device from being stolen by unauthorized users during the use intermission of an authorized user. Correspondingly, the mobile device also reports its latest status information to the surveillance server after resuming to locked status automatically, so that the surveillance server can update the recorded status information of the mobile device in time.

FIG. 2B describes the steps to be executed in surveillance server 50 of the anti-theft system as shown in FIG. 1. As shown in FIG. 2B, when the surveillance server receives signals sent from the mobile device via WLAN or WWAN (step S110), it first determines whether the transferred signals are alarm signal (step S120).

If the transferred signals are alarm signal, the surveillance server issues an alarm and displays the alarm signal on a display means (step S130), wherein the display means can be a display screen at the surveillance server or a lighting means for alarming controlled by the surveillance server and the lighting means is deployed in the predefined surveillance area formed by the plurality of docks.

If the transferred signals are not alarm signal, it's to be determined whether the transferred signals are the identification information of the dock to which the mobile device belongs (step S140). If the answer is yes, the transferred identification information of the dock to which the mobile device belongs will be recorded in the database of the surveillance server and the status information of the mobile device in locked status will be recorded in the database of the surveillance server too (step S150); if the answer is no, it's to be determined whether the transferred signals are user ID and/or password for unlocking (step S160).

If the transferred signals are user ID and/or password, the surveillance server determines whether the user ID and/or password are/is correct. If yes, the status of the mobile device recorded in the database is set to unlocked status and the confirmation information about the authorization is sent to the mobile device (step S170).

If the transferred signals are not user ID and/or password, the surveillance server executes the corresponding operation based on the content of the transferred signals (step S180). For example, if the mobile device detects whether it has left the dock to which it belongs at predefined intervals (such as 2 s), the surveillance server checks whether it has received the report of the detection result as scheduled. If failing to receive the report of detection result within a predefined time period, the surveillance server not only issues an alarm but also displays the alarm signals on a display means.

In addition to monitoring the mobile devices in the predefined surveillance area to prevent the mobile devices from being stolen, the surveillance server can also display and track the current position of each guarded mobile device and the related information on the display screen in real time, based on the recorded status information of each mobile device and the identification information of the dock to which it belongs. For example, whether the mobile device is within the surveillance area currently: if the mobile device is in the surveillance area, the identification information of the specific dock will be displayed; whether someone is using the mobile device currently: if it's being used now, the identification information of the specific user will be displayed.

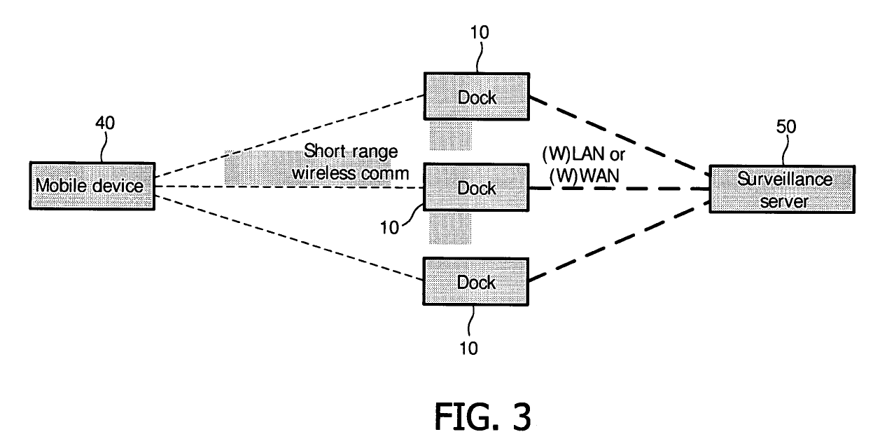

FIG. 3 is the schematic diagram illustrating the anti-theft system sending alarm signals to the surveillance server via the docks (i.e. the dock is the active peer) in accordance with another embodiment of the present invention. As shown in FIG. 3, a plurality of docks 10 can be deployed in a predefined surveillance area (e.g. office building or plant area), each dock 10 comprising an active peer. According to the radio range of Mifare, each dock sends radio signals to detect whether there exists mobile device 40 within its surveillance area, and reports the information about the mobile device to surveillance server 50 after finding mobile device 40. When detecting that mobile device 40 within its surveillance area leaves the surveillance area without permission, the dock sends alarm signals to surveillance server 50. Here, the coverage area with the dock 10 as center and the radio to range as radius is called the surveillance area of the dock 10.

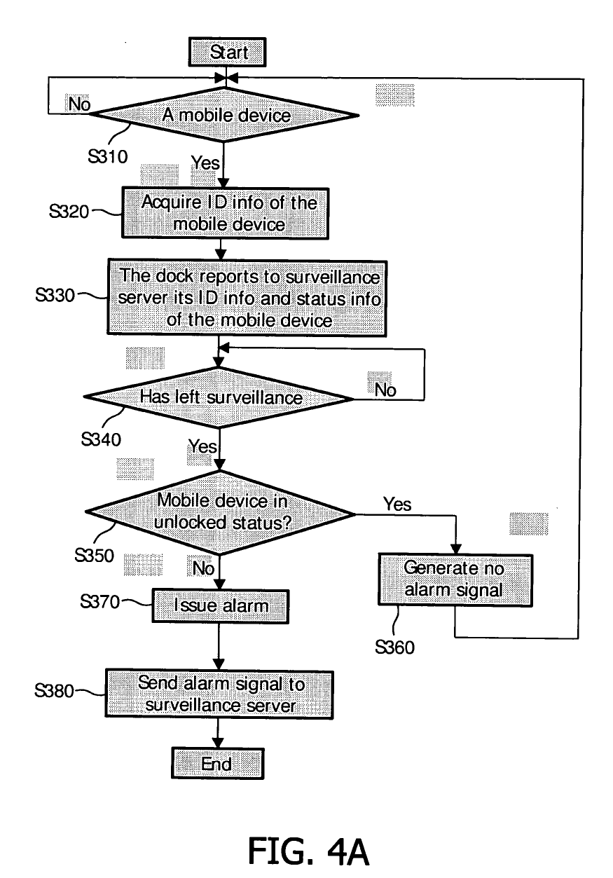

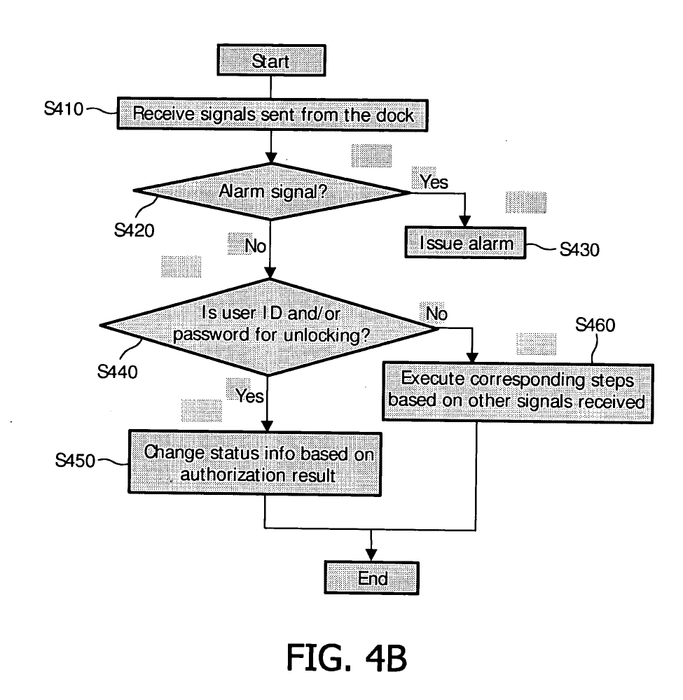

FIG. 4A and FIG. 4B illustrate respectively the steps to be executed in dock 10 and those in surveillance server 50 shown in FIG. 3.

As shown in FIG. 4A, first, a dock sends radio signals to detect whether there exists a mobile device within its surveillance area (step S310). If a mobile device is in the surveillance area of the dock, the mobile device activated by the radio signals will establish radio link with the dock.

After the radio link is established, the dock acquires the identification information of the mobile device via the short range wireless communication with the mobile device (step S320). Same as the above embodiment, the dock sets the status of the mobile device in its surveillance area to locked status when establishing the radio link. Through the radio link between the mobile device and the dock, the mobile device is locked in the surveillance area of the dock in form of an electronic lock.

Assuming that each dock in the anti-theft system has its respective identity, the dock reports to the surveillance server via wire/wireless LAN or wire/wireless WAN its identity and the current status information of the mobile device within its surveillance area (step S330).

When the mobile device move in the surveillance area of the dock, the dock determines whether the mobile device leaves its surveillance area based on detecting whether the radio link between the mobile device and the dock breaks (step S340).

If the dock detects that the mobile device is leaving its surveillance area, it detects whether the current status of the mobile device within its surveillance area has changed to unlocked status from locked status (step S350).

In the embodiment of the present invention, the dock can receive user ID and/or password from user input via smart card or keyboard. After performing authentication procedure with the surveillance server and receiving the confirmation message indicating that the inputted user ID and/or password are/is from an authorized user, the dock changes the current status of the mobile device within its surveillance area from locked status to unlocked status.

At this time, the dock has unlocked all mobile devices in its surveillance area, the unlocked status should have a strict time restriction in order to prevent the mobile devices within the surveillance area from being stolen by unauthorized users, e.g. the time limit is 2 seconds for every unlocking. If the dock detects a mobile device in its surveillance area after the time limit expires, the dock changes the current status of the mobile device within its surveillance area from unlocked status to locked status again. In the same manner, after changing to locked status, the dock reports the latest status information of the mobile devices in its surveillance area to the surveillance server so that the surveillance server can update the recorded status information of the mobile devices in time.

If the dock detects at step S350 that a mobile device within the surveillance area of the dock is in unlocked status, the mobile device can leave the surveillance area without being generated alarm signals (step S360); however, if the mobile device is still in locked status, the dock not only issues alarm (step S370) but also sends to the surveillance server an alarm signal, to warn the surveillance server that the mobile device within the surveillance area of the dock is possibly being stolen (step S380).

Preferably, the dock reports regularly to the surveillance server at predefined intervals (2 second, for example) the detection result about the mobile devices within its surveillance area, which can enable the surveillance server to issue an alarm when failing to receive the detection report as scheduled, and thus avoid the case that the thief cuts the power supply component and thus steals the mobile device.

FIG. 4B illustrates the steps to be executed in the surveillance server of the anti-theft system shown in FIG. 3. As shown in FIG. 4B, when the surveillance server receives signals transferred via wire/wireless LAN or wire/wireless WAN from the dock (step S410), it first determines whether the transferred signals are alarm signal (step S420).

If the transferred signals are alarm signal, the surveillance server issues alarms and displays the alarm signals on a display means (step S430).

If the transferred signals are not alarm signal, it's to be determined whether the transferred signals are the user ID and/or password of the mobile device within the surveillance area of the dock from user input via smart card or keyboard (step S440).

If the transferred signals are user ID and/or password, the surveillance server determines whether the user ID and/or password are/is correct. If yes, set the status of the mobile device recorded in the database to unlocked status and send the confirmation information about the authorization to the dock (step S450).

If the transferred signals are not user ID and/or password, the surveillance server executes the corresponding operation based on the transferred signals (step S460). For example, if the transferred signals are information reported from the dock about resuming the status of mobile devices within its surveillance area from unlocked status to locked status after a predefined time limit expires, the surveillance server will update the recorded status information of the mobile devices timely based on the report.

Further, if the surveillance server fails to receive the detection report from the dock about the status of the mobile devices within its surveillance area as schedule, the surveillance server not only issues an alarm but also displays the alarm signals on a display means.

The proposed anti-theft system equipped with Mifare communication interface can also be implemented with other short range wireless communication protocols. If NFC (Near Field Communication) interface is employed, both the dock and the mobile device can act as the active peer, thus to realize peer-to-peer communication mode, or abbreviated as P2P communication mode.

When the present invention adopts P2P communication mode, the implementations of the above two specific embodiments can have various modifications. For example, when P2P communication mode is applied in the above second embodiment, user authentication can be performed via the radio link between the mobile device and the surveillance server. In this mode, when the dock detects a mobile device in the surveillance area attempts to leave the surveillance area, the dock checks whether the current status of the mobile device has changed from locked status to unlocked status, through sending a poll request to the mobile device. The mobile device feeds the authorization information from the surveillance server as poll response back to the dock, so that the dock can monitor each mobile device within its surveillance area and send alarm signals timely and accurately to the surveillance server when an unauthorized user steals the mobile device.

In practical applications, different communication interfaces and surveillance modes can be adopted based on the corresponding requirements. For example, in the above second embodiment, Mifare communication interface with the dock as the active peer while the mobile device as the passive peer can be employed, so as to simplify the configuration of the mobile device. In this case, if a contactless tag is pasted on the mobile device, the dock equipped with a reader can read information on the tag in a wireless way, thus to realize the above surveillance procedure. It's equally applicable to the surveillance of other expensive articles, if only a Mifare tag is pasted on the monitored expensive article. If the anti-theft system demands the dock to monitor each mobile device within the surveillance area respectively and decides whether to issue alarms based on the current status of each specific device, NFC interfaces with both the dock and the mobile device as the active peer can be applied to realize surveillance operations.

As to the anti-theft method using short range wireless communication technologies in the present invention, it can be implemented in software or in hardware, or in combination of both.

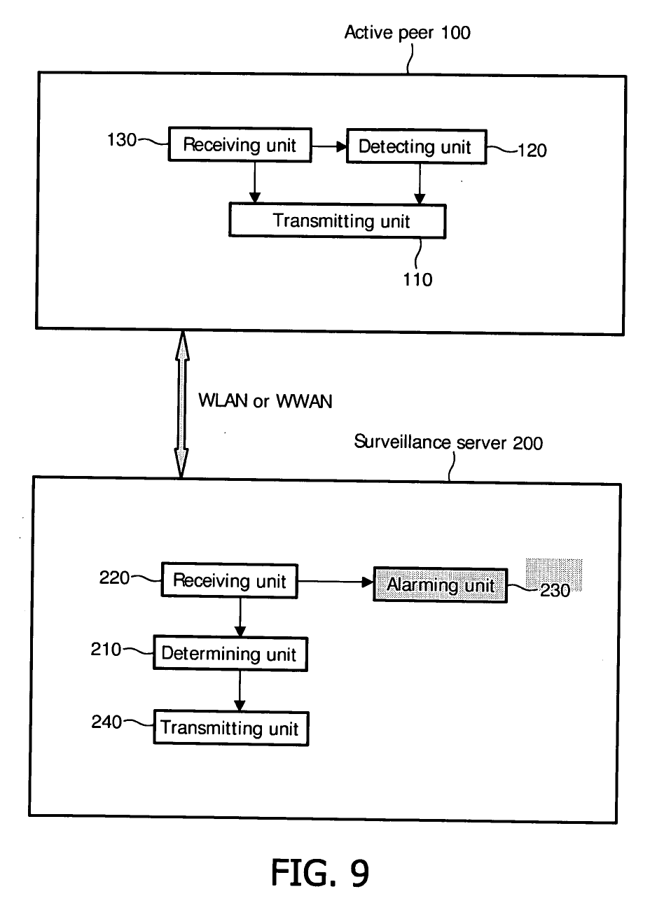

FIG. 5 illustrates the configurations of the active peer for sending alarm signals to the surveillance server and the surveillance server for generating alarms in accordance with an embodiment of the present invention when the proposed anti-theft method is implemented in hardware, wherein the components same as those in conventional active peers based on Mifare and conventional servers are not given here.

As stated in the above anti-theft method of the present invention, referring to the proposed anti-theft system, of the mobile device under surveillance and the dock for performing surveillance, the one having power supply component acts as the active peer and the other one as the passive peer. When the mobile device leaves the surveillance area of the dock without permission, the one as the active peer is responsible for sending alarm signals to the surveillance server, to alert that the mobile device is possibly being stolen.

As shown in FIG. 5, the active peer 100 such as dock 10 in FIG. 3 (or alternatively mobile device 40 in FIG. 1), comprises: a transmitting unit 110, for transmitting radio RF signals to a passive peer, to detect whether the mobile device is in the coverage area of the radio range of a dock having the active peer; a detecting unit 120, for checking whether the mobile device is permitted to leave the dock when detecting that the mobile device is going to leave the area of the dock (it's assumed that the mobile device is initialized unallowed to leave the dock to which it belongs at default ); wherein the transmitting unit sends an alarm signal to a surveillance server 200 if the checking result shows that the monitored object is not permitted to leave the dock.

The active peer 100 further comprises: a receiving unit 130, for receiving information about user ID and/or password from user input via smart card or keyboard; and the active peer sends the user ID and/or password to the surveillance server 200 via transmitting unit 110.

After surveillance server 200 receives the user ID and/or password, determining unit 210 determines whether the mobile device is permitted to leave the dock based on the user ID and/or password, and sends the determination result to the active peer via transmitting unit 240.

Receiving unit 130 in the active peer 100 receives the determination result from surveillance server 200, so as to provide updated information when the above detecting unit 120 checks whether the mobile device is allowed to leave the dock.

If receiving unit 220 in surveillance server 200 receives the alarm signal from the active peer, alarming unit 230 will generate an alarm, to alert that some mobile device within the surveillance area of the dock is possibly being stolen.

### BENEFICIAL RESULTS OF THE INVENTION

As described above, with regard to the anti-theft system using short range wireless communication technologies as proposed in the present invention, the public shared mobile devices are locked in the surveillance area constructed by several docks in the form of electronic lock. When a mobile device in locked status is brought out of the surveillance area, an alarm signal will be sent timely to a surveillance server controlled by the administrator, and thus the proposed anti-theft system can effectively prevent public articles from being stolen.

Further, since the surveillance server can provide the current position of the monitored public article and related user information, the anti-theft system is advantageous to the establishment and improvement for management of public shared articles.

It's to be understood by those skilled in the art that the anti-theft method and apparatus as disclosed in this invention can be made of various modifications without departing from the spirit and scope of the invention as defined by the appended claims.

1. An anti-theft method to be executed in an active peer, comprising the steps of:
(a) transmitting radio RF signal to a passive peer to detect whether one of the active peer and the passive peer as a monitored object is in an area covered by radio range of the other one of the active peer and the passive peer as a dock;
(b) checking whether the monitored object is permitted to leave the dock when detecting that the monitored object is going to leave the area of the dock;
(c) sending an alarm signal to an alarm apparatus if the monitored object is not permitted to leave the dock.

2. The anti-theft method according to claim 1, wherein the alarm apparatus is a surveillance server and the surveillance server receives the alarm signal in wire or wireless way.

3. The anti-theft method according to claim 2, wherein step (a) further comprises:
reporting the detected information about whether the monitored object is in the area of the dock to the surveillance server.

4. The anti-theft method according to claim 2, further comprising the step of:
receiving information inputted by an user that the monitored object is permitted to leave the dock;
sending the inputted information to the surveillance server;
receiving response information from the surveillance server about whether the monitored object is permitted to leave the dock, the response information being obtained from determination of the surveillance server based on the inputted information.

5. The anti-theft method according to claim 4, wherein the inputted information includes user ID and/or password.

6. The anti-theft method according to claim 4, wherein the user inputs the information via a smart card or keyboard.

7. The anti-theft method according to claim 1, wherein at the step (a), the active peer sends radio RF signals periodically, to detect whether the monitored object is in the area of the dock.

8. The anti-theft method according to claim 1, wherein if the monitored object is the active peer, further comprising the step of:
detecting whether the monitored object is moved;
starting operation of step (a) when detecting the monitored object is moved.

9. An anti-theft method to be executed in a surveillance server, comprising the steps of:
receiving an alarm signal sent from an active peer, the alarm signal indicating that a monitored object leaves an area covered by radio range of a dock without authorization, wherein one of the monitored object and the dock having power supply component acts as the active peer while the other one acts as a passive peer to receive radio RF signals sent from the active peer;
generating an alarm indication based on the alarm signal.

10. The anti-theft method according to claim 9, further comprising the step of:
receiving information sent from the active peer about that the monitored object is permitted to leave the dock, the information being inputted to the active peer by a user via a smart card or keyboard;
determining whether the user is an authorized one based on the information; sending determination result to the active peer.

11. The anti-theft method according to claim 10, further comprising the step of:
displaying related information about that the monitored object is currently being used, based on the information about that the monitored object is permitted to leave the dock.

12. The anti-theft method according to claim 9, further comprising the step of:
receiving detection report sent from the active peer, the detection report being obtained from the active peer by detecting whether the monitored object is in the area of the dock.

13. The anti-theft method according to claim 12, further comprising the step of:
displaying current location of the monitored object based on the detection report.

14. The anti-theft method according to claim 12, further comprising the steps of:
detecting whether the detection report is received every predefined time period;
generating an alarm indication if the detection report is not received within a predefined time period.

15. The anti-theft method according to claim 14, further comprising the step of:
sending a control signal based on the alarm indication, the control signal used for controlling an alarming apparatus near the dock to issue alarms.

16. An active apparatus, comprising:
means for transmitting radio RF signals to a passive peer, to detect whether one of the active peer and the passive peer as a monitored object is in an area covered by radio range of the other one of the active peer and the passive peer as a dock;
means for checking whether the monitored object is permitted to leave the dock when detecting that the monitored object is going to leave the area of the dock;
wherein the transmitting means again sends an alarm signal to a surveillance server if the checking result shows that the monitored object is not permitted to leave the dock.

17. The active apparatus according to claim 16, further comprising:
means for receiving information of user ID and/or password inputted by a user;
the receiving means again receives response information from the surveillance server after the transmitting unit sends the information inputted by the user to the surveillance server;
wherein the response information is determined by the surveillance server whether the monitored object is permitted to leave the dock based on the information inputted by the user.

18. A surveillance server, comprising:
means for receiving an alarm signal sent from an active peer, the alarm signal indicating that a monitored object leaves an area covered by radio range of a dock without authorization, wherein one of the monitored object and the dock having power supply component acts as the active peer while the other one acts as a passive peer to receive radio RF signals sent from the active peer;
means for generating an alarm indication based on the alarm signal.

19. The surveillance server according to claim 18, further comprising:
means for determining whether the monitored object is permitted to leave the dock, based on the information when the receiving means receives information of user ID and/or password from the active peer;
means for sending the determination result to the active peer.
